(19) United States
(12) Patent Application Publication
(10) Pub. No.: US 2013/0124227 A1
(43) Pub. Date: May 16, 2013

(54) TRACKING SYSTEM FOR HEALTHCARE FACILITIES

(71) Applicant: PRECISION DYNAMICS CORPORATION, Valencia, CA (US)

(72) Inventor: Rick Ellis, Lexington, MA (US)

(73) Assignee: PRECISION DYNAMICS CORPORATION, Valencia, CA (US)

(21) Appl. No.: 13/675,839

(22) Filed: Nov. 13, 2012

Related U.S. Application Data
(60) Provisional application No. 61/559,758, filed on Nov. 15, 2011.

(51) Int. Cl. G06Q 50/24

(52) U.S. Cl. 705/3

(57) ABSTRACT

A location/tracking system for use in hospitals and similar healthcare facilities is based upon a “last seen” location for patients, clinicians, or high value equipment. The system uses portal readers to determine when and where an item to be tracked passes through a portal, bed or exam chair mounted proximity reader to determine when and how long an item is proximate to a reader in order to determine when and for how long the item is proximate to a particular task area. Real time tracking and retrospective analysis of transaction data enables locating an item to be tracked and allows higher level analysis of the transaction data to determine metrics for “time to test”, “time to treatment”, and similar statistics.

### BACKGROUND OF THE INVENTION

The present invention concerns a low cost system and method for tracking interactions between assets in a patient care environment. In this disclosure, “assets” means: (1) persons or entities, such as patients, caregivers, visitors, etc.; (2) rooms or stations, such as exam rooms, operating rooms, ICU, recovery, etc.; and (3) equipment or objects, such as, hand wash dispensers, testing or diagnostic machines, washing stations, etc. More particularly the present invention concerns a system that computes patient care environment effectiveness metrics by comparing a sequence of interaction records to a sequence of expected interactions in which each interaction record documents an interaction between two or more entities (e.g., caregivers, patients, and equipment) in the patient care environment.

Real Time Location Systems (RTLS) have become popular in hospitals as a way to reduce costs and improve efficiency through real time access to information. Tasks such as locating an available piece of equipment, a patient or a clinician are made much faster with RTLS. In addition, workflow within the healthcare setting can be better controlled with the use of RTLS. A unit manager or charge nurse can have real time access to information staffing levels and patient flow as well as access to stored data for use in process improvement efforts.

In practice however, RTLS systems have been found to be expensive to implement and prone to technical challenges. In order to attain granularity in location (down to sub 1 meter) and overcome spatial anomalies (RFID systems are not bound by walls, floors or ceilings), many suppliers have turned to hybrid systems which use both an RFID component and an infrared or ultrasound component. In addition, the density of receivers may be increased to achieve coverage. The resulting systems are expensive and very difficult to maintain.

There is a continuing need to improve the tracking of patients, caregivers, equipment, and processes in healthcare facilities such as hospitals. Purposes for doing so include verifying that patients are receiving proper care real time and to measure various patient care environment metrics that measure treatment cost and effectiveness. The former allows corrective action to be taken in the event that care is needed. The latter allows for longer-term improvements in policies and procedures that benefit patients and reduce waste.

To provide this tracking some healthcare facilities have at least partially adopted RTLS that allow a central computer system to continuously track the location of every asset or person throughout a hospital. The spatial accuracy of these systems can be down to one meter locational granularity. Accomplishing this granularity of tracking is technically challenging and expensive both to implement and maintain. This is particularly the case for a large facility. As a result RTLS has been only partially implemented. What is needed is a system that lends itself to a complete patient care environment implementation without undue cost.

### SUMMARY OF THE INVENTION

A patient care environment tracking system according to the present invention reduces cost and complexity relative to existing RTLS-only systems by focusing data collection upon discrete interactions between entities. Examples of entities include patients, caregivers, equipment, wash stations, glove and/or robe stations, patient beds, supplies, specimen containers, patient charts, patient family members, patient visitors, and portals or entrances to rooms to name a few. The patient care environment tracking system includes a computer system and a database coupled to a network. The computer system stores and executes software modules including a data capture module, an IS plan (interaction sequence plan) tracking module, and an analytics and dashboard module.

The present invention seeks to reduce cost and complexity by focusing data collection on critical elements of location. While real time location to within 1 meter for clinicians and patients would be desirable, it has been found that “last seen” location is sufficient for most cost reduction and efficiency improvement programs. By recognizing when patients, clinicians or high value equipment enters or leaves a room and coupling that with information on when clinicians or equipment is in close proximity to a patient, a sufficient amount of needed location information is available. Simpler, less expensive “portal type” readers and bed mounted proximity readers provide this level of data.

In a system for gathering real time location based transaction data, real time tracking as well as retrospective analysis of the care process are both enabled. Such a transaction is defined as an interaction of caregiver with patient, a person entering or leaving an area, a high value asset in proximity to patient, or a caregiver in proximity to “task locations” such as hand wash stations, charting stations, medication preparation areas etc.

According to the present invention readers such as RFID readers are distributed at various selected locations throughout the patient care environment. Examples of the selected locations include patient beds, wash stations, glove and/or robe stations, portals (entrances), and on important (sometimes fixed location) equipment. In an exemplary embodiment the readers are distributed throughout the entire patient care environment.

The readers are connected to the network and as a group are continuously inputting reading data to the network in response to reader and tag interaction which is indicative of entity interaction. A data element is generated in response to a reader reading a tag and contains: (1) an identification corresponding to the reader; (2) an identification corresponding to the tag; and (3) a timestamp for the time of reading. In some embodiments the data element also contains a location of the reader.

The data capture module is configured to (1) receive data elements from a plurality of readers distributed throughout the patient care environment and linked to the network, each data element including a reader identification identifying one of the readers, a tag identification identifying a tag read by the reader, and a timestamp indicating a time that the reader read the tag and to (2) store interaction records in a database wherein each interaction record corresponds to or contains one or more of the data elements.

The IS plan tracking module is configured to track and analyze a plurality of interaction sequences. For each IS plan the IS tracking module is configured to (1) receive IS plan information indicative of a caregiver, a patient, an expected sequence of interactions, and an IS plan time period, (2) search the database for associated interaction records having timestamps within the IS plan time period and having the caregiver tag ID, and the patient tag ID, (3) compare the associated interaction records with the expected sequence of interactions, and (4) generate a metric based upon the comparison. Part of this process may be the determination of whether a particular protocol has properly taken place. The protocol may be a standard for providing care to a patient. Alternatively the protocol may be a standard for preventing spread of infection.

The analytics and dashboard module is configured to analyze metrics and/or other data from the IS plan tracking module and to display a retrospective summary of measures and metrics for the patient care environment. The analysis and display may be programmed to occur regularly and automatically and/or it may occur in response to a query received by the computer system. The displayed summary may include a convenient dashboard format.

Although the foregoing primarily describes system function in terms of three software modules (data capture, tracking, and analytics/dashboard) it is anticipated that this system can be implemented as one large software module or more than three software modules. The modules can be operated on a single computer or there can be a separate computer for each module. There may be more than one computer for a particular module and/or more than one module executed on a single computer. Thus many specific implementations are possible.

The present invention is directed to a process for performing asset tracking in a patient care environment. The invention may also include a non-transitory computer readable medium having stored thereon computer executable instructions for performing asset tracking in a patient care environment, i.e., the above process The process and/or executable instructions involve receiving a plurality of data elements from a tracking system in the patient care environment. Each data element has a reader identification code corresponding to one of a plurality of readers distributed throughout the facility, a tag identification code corresponding to an identification tag attached to one of a plurality of assets and read by one of the readers, and a timestamp corresponding to a time that the identification tag was read by the reader. The tracking system may preferably be a real-time tracking system.

Interaction records corresponding to one or more of the plurality of data elements received from the tracking system are stored in an electronic database. A plurality of interaction sequence plans are generated, with each interaction sequence plan including a defined time period and an expected sequence of interactions between assets in the patient care environment during the defined time period. The plurality of interaction sequence plans may be generated based upon an alert from patient monitoring equipment, or arise from or in response to a doctor's order. The interaction sequence plan is preferably received in a computer processor.

An analysis is performed for each interaction sequence plan. The analysis involves searching the database and identifying interaction records in the database having timestamps within the defined time period and identification data corresponding to one or more of the assets. The identified interaction records are compared with the expected sequence of interactions. A metric based upon the comparison of the identified interaction records with the expected sequence of interactions is generated.

The defined time period preferably includes a maximum time period and an expected time period. The expected time period falls within and is shorter in duration than the maximum time period. The searching and identifying steps are performed over the maximum time period such that interaction records are identified that are outside of the expected time period.

The analysis also involves assembling a temporal sequence of the identified interaction records before comparing them with the expected sequence of interactions. The metric is based upon how closely the temporal sequence of the identified interaction records matches the expected sequence of interactions. A retrospective analysis may be performed on metrics generated for a plurality of interaction sequence plans.

Input data records are preferably continuously stored in the electronic database, each input data record containing one of the data elements. Each interaction record corresponds to one or more input data records and at least some interaction records correspond to more than one input data record. Alternatively, each interaction record corresponds to one of the input data records.

The present invention is also directed to a system for performing asset tracking in a patient care environment. The system includes a computer processor and electronic database connected to a network. The computer processor includes a data capture module configured to track assets in the patient care environment and a data analysis module configured to analyze a plurality of interaction sequence plans.

The data capture module is programmed to receive a plurality of data elements from a tracking system in the patient care environment. Each data element has a reader identification code corresponding to one of a plurality of readers distributed throughout the facility, a tag identification code corresponding to an identification tag attached to one of a plurality of assets and read by one of the readers, and a timestamp corresponding to a time that the identification tag was read by the reader. The data capture module is also programmed to store interaction records in the electronic database, wherein each interaction record corresponds to one or more of the plurality of data elements received from the tracking system.

The data analysis module is programmed to generate a plurality of interaction sequence plans. Each interaction sequence plan included a defined time period and an expected sequence of interactions between assets in the patient care environment during the defined time period. The data analysis module is also programmed to search the database and to identify interaction records in the database having timestamps within the defined time period and identification data corresponding to one or more of the assets. The module compares the identified interaction records with the expected sequence of interactions and generates a metric based upon the comparison of the identified interaction records with the expected sequence of interactions.

The data analysis module is further programmed to assemble a temporal sequence of the identified interaction records before comparing them with the expected sequence of interactions. The metric is based upon how closely the temporal sequence of the identified interaction records matches the expected sequence of interactions. The data analysis module is also programmed to perform a retrospective analysis on metrics generated for a plurality of interaction sequence plans.

The data capture module is further programmed to continuously store input data records in the electronic database, each input data record containing one of the data elements. The tracking system is preferably a real-time tracking system, wherein the plurality of readers are linked to the network and a plurality of identification tags attached to the assets in the patient care environment.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a block diagram of an exemplary embodiment of a system according to the present invention;

FIG. 2 is an illustrative drawing depicting tagged entities including a caregiver, a patient, and medical equipment;

FIG. 3 is a floor plan of a patient care environment depicting a typical deployment of tag readers according to the present invention;

FIG. 4A is an illustrative drawing of a hospital bed that includes a reader;

FIG. 4B is an illustrative drawing of older hospital beds and chair designs containing retrofit readers;

FIG. 4C is an illustrative embodiment depicting the read range of a reader integrated into a hospital bed;

FIG. 4D is an illustrative embodiment depicting the read range of a reader retrofitted onto an older hospital bed;

FIG. 5 is a block diagram representation of an exemplary embodiment of a system according to the current invention;

FIG. 6 is a block diagram illustrating data process flow through an exemplary embodiment of software modules according to the present invention;

FIG. 7 is a flowchart depicting exemplary data processing to convert input data records into interaction records;

FIG. 8 is a flowchart depicting a process for tracking and analyzing an interaction sequence plan for a caregiver to provide a service to a patient;

FIG. 9 is a flowchart depicting a process for generating a dashboard that illustrates retrospectively how well a patient care environment is performing relative to defined metrics;

FIG. 10A is first illustrative embodiment of a dashboard according to the present invention;

FIG. 10B is a flowchart depicting a process by which the data illustrated in the dashboard of FIG. 10A may be generated;

FIG. 11 is second illustrative embodiment of a dashboard according to the present invention;

FIG. 12 is third illustrative embodiment of a dashboard according to the present invention; and

FIG. 13 is fourth illustrative embodiment of a dashboard according to the present invention.

### DETAILED DESCRIPTION OF THE PREFERRED EMBODIMENTS

The present invention is directed to a location/tracking system that reports interactions between identification tags of various assets in a patient care environment based upon proximity of such identification tags with readers and the time of the proximity. This type of system may also report based upon a Real Time Location System (RTLS) or a “last seen” location method. Certain of the figures illustrate the inventive system schematically and/or diagrammatically, while other figures illustrate various data display, collection and interpretation features of the present invention.

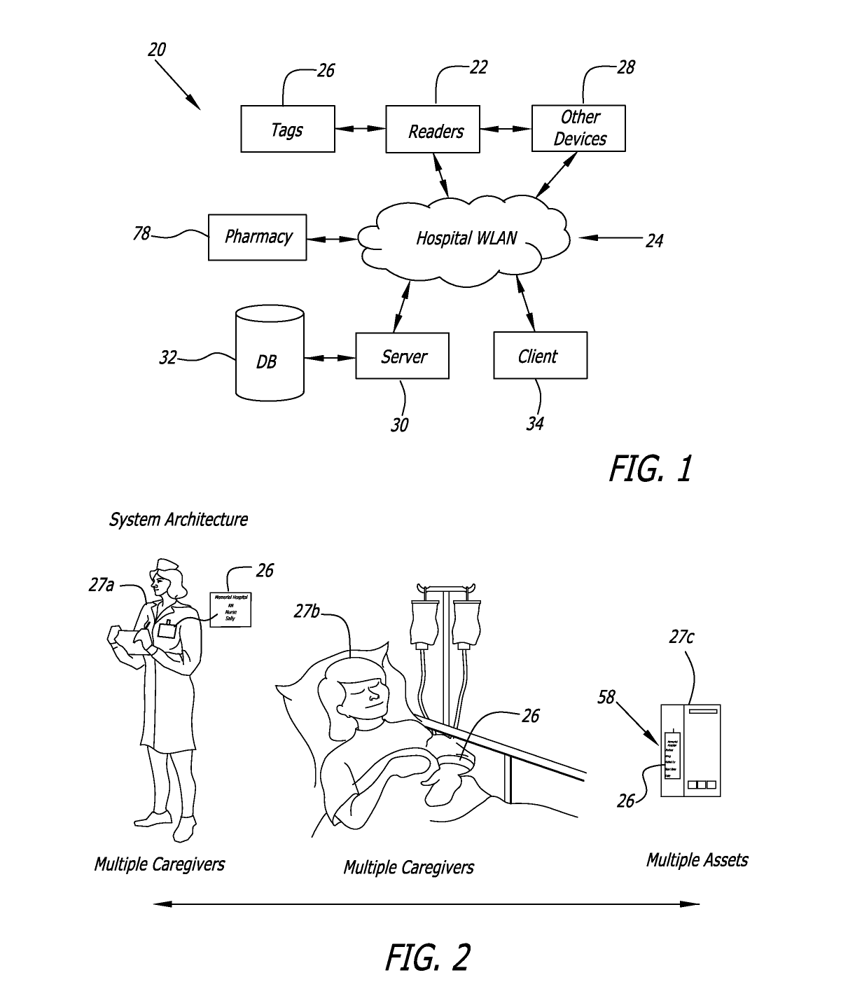

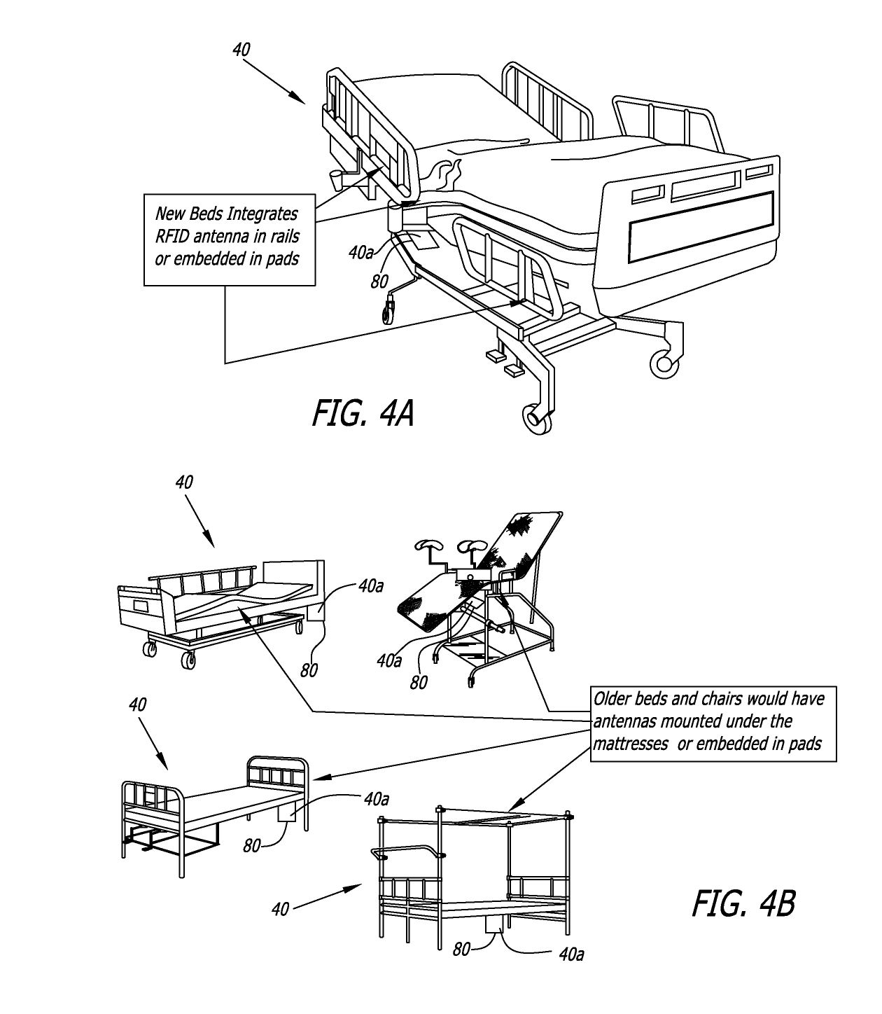

An exemplary patient care environment tracking system 20 according to the present invention is depicted in FIGS. 1, 2, 3, 4A and 4B. The system 20 includes readers 22, a network 24, identification tags 26, miscellaneous devices 28, a computer server 30, a database 32, and client devices 34. The readers 22 are distributed throughout a patient care environment 36 (FIG. 3) such as a hospital. Exemplary locations of tag readers include portals or entrances to rooms 38, patient beds 40 (e.g., hospital beds), hand wash stations 42, medical equipment 44, glove and robe stations 46, examination rooms 48, operating rooms 50, surgical wards 52, emergency rooms 54, and diagnostic rooms 56, i.e., rooms with imaging/testing equipment to name a few examples. The readers 22 are configured to continuously gather data from identification tags 26 and provide that data to the computer server 30 via the network 24. Each of a plurality of the identification tags 26 are associated with an asset 27, representing a person/entity, a room/station, or equipment/object as defined above. In an exemplary embodiment, the readers 22 are RFID (radio frequency identification) readers and the tags 26 are RFID tags.

Other miscellaneous devices 28 may also provide data to the system 20. One example may be a patient monitoring device 58 that provides monitoring data or an alert based on a monitoring parameter reaching a threshold or critical level. For example, a cardiac parameter may trigger an alert. Other devices 28 may also include RTLS devices that provide spatial location data of assets 27.

The computer server 30 receives data from readers 22 and other devices 28 and stores the data in database 32. Computer server 30 may be one or more servers, one or more mainframe computers, or any of a number of other configurations. As will be described more fully below, computer server 30 receives a data element 60 each time a reader 22 detects an identification tag 26. The data element 60 includes a reader ID 62 that is indicative of the reader 22 that detected the tag 26, a tag ID 64 that is indicative of the particular identification tag 26 detected, and a timestamp 66 that documents the time that the detection took place. The data element 60 may include other information such as information indicative of the location of the reader 22.

Based on the tag reading the computer server 30 stores an input data record 68 in database 32 that contains the data element 60. In one embodiment, the computer server 30 defines interaction records 70 that are each based upon one or more input data records 68. Alternatively, the input data records 68 and the interaction records 70 are the same. Each interaction record 70 is indicative of the “last seen” location of one or more assets 27 whose tags 26 were detected by a reader 22.

Computer server 30 is configured to track interaction sequences between assets 27. An interaction sequence plan (IS plan) 72 may define a procedure or treatment, i.e., a task that a caregiver needs to perform for a patient. Computer server 30 tracks the IS plan 72 by querying and analyzing the interaction data records 70 stored in database 32. Client system 34 allows a caregiver to look up the status of an IS plan 72 or to view a dashboard 74 that provides information regarding the effectiveness of different aspects or caregivers of the patient care environment. The dashboard 74 may also provide the “last seen” location of all or selected assets 27 based upon scan data of their respective tags 26.

In an exemplary embodiment, database 32 includes a medical administrative record 76 for the facility 36. Accordingly the various methods and systems described in the foregoing are documented and tracked in the medical administrative record 76. The system 20 may also be linked to a pharmacy 78. When supplies or medications are ordered pursuant to an IS plan 72 the orders may be passed to the pharmacy 78.

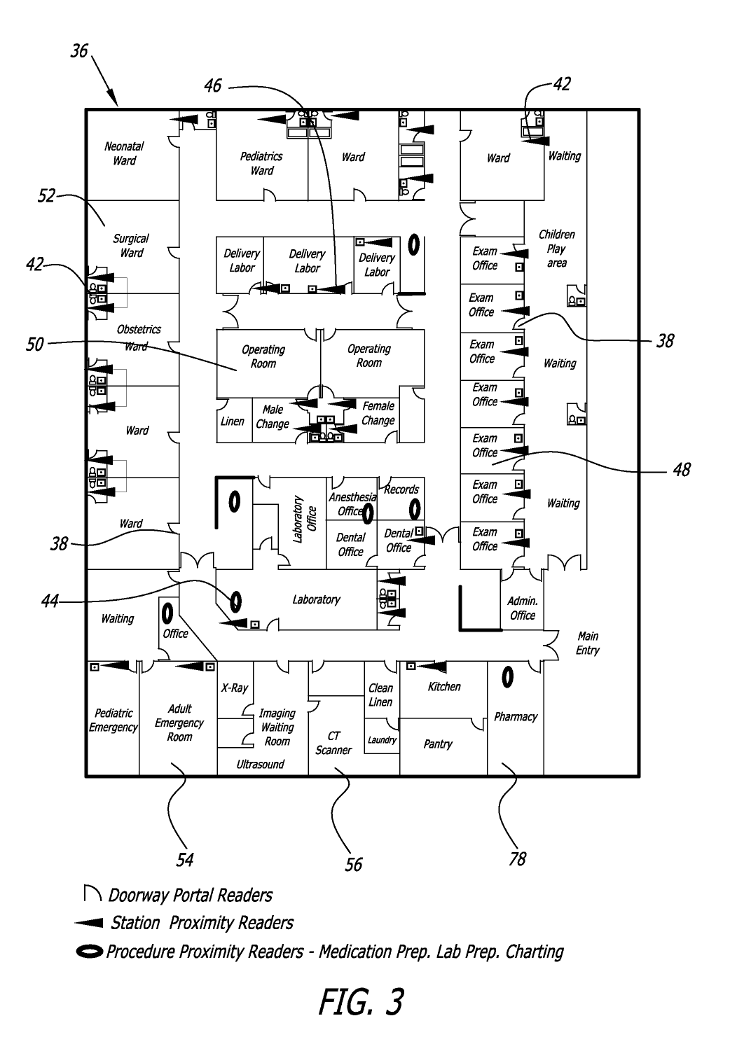

As depicted in FIG. 2, each tag 26 is associated with an asset 27 such as a caregiver 27a, a patient 27b, or equipment 27c. A caregiver 27a can refer to a doctor, nurse, nurse practitioner, or any other person that provides a service to a patient. Equipment 27c can refer to IV (intravenous) pumps, monitoring equipment, surgical trays, or IV drip systems, to name a few examples. Tags 26 can also be associated with specimens taken from patients such that patient identifications and specimens can be linked via tag interactions. Alternatively, the linking may be done by scanning a barcode on a specimen container.

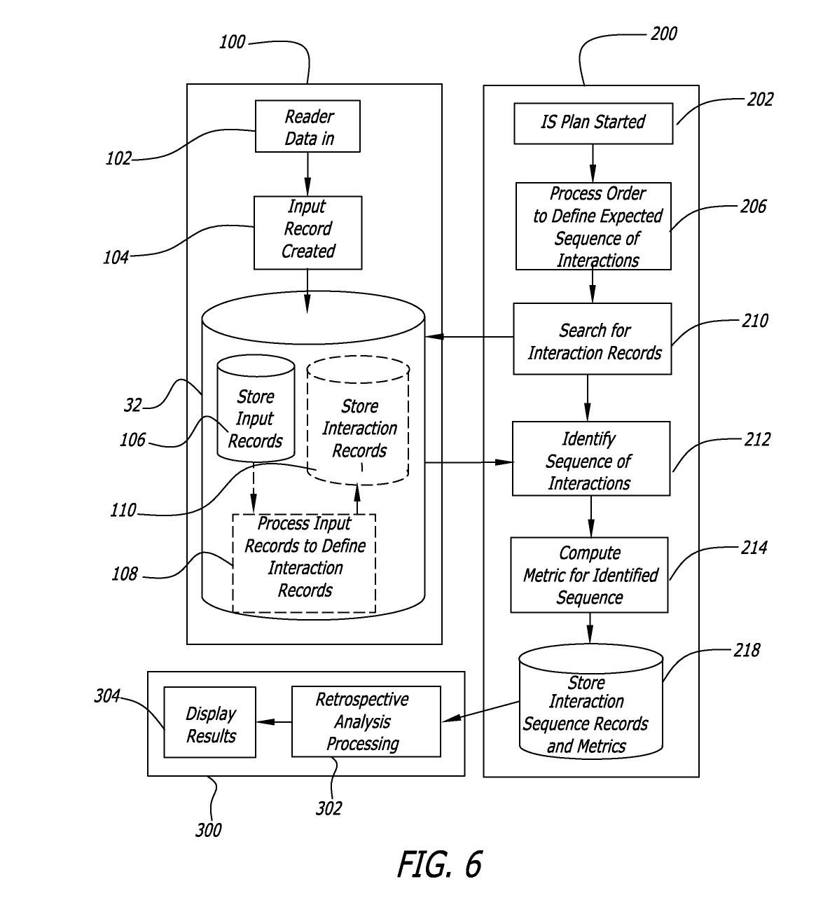

In an exemplary embodiment, a computing device 80 is integrated into or mounted onto a hospital bed 40. The computing device 80 according to this embodiment captures information from tags 26 that are in proximity to a reader 22 that associated with the bed 40 and linked to the computing device 80. In this embodiment, computing device 80 functions as part of a data capture module 100 (discussed further below in connection with FIG. 6) that captures data from any tags 26 that are in the read range of reader 22 associated with computing device 80. Other such computing devices 80 may be mounted or located at other locations such as portals 38, wash stations 42, medical equipment 44, glove/robe stations 46, exam rooms 48, operating rooms 50, surgical wards 52, emergency rooms 54 and diagnostic rooms 56, to name a few examples. Other locations for which a provider may reasonably want to track interactions may be included.

FIG. 3 depicts a floor plan of a patient care environment 36 such as a hospital. The floor plan indicates potential locations of readers 22. Portal readers 38a can be mounted in doorways and entrances to track when an asset 27, i.e., a caregiver 27a, a patient 27b, or equipment 27c, passes through the portal. Hand wash proximity readers 42a are mounted at hand wash stations 42 to verify the proper use of hand washing procedures by a caregiver 27a. Additional proximity readers 22 may be mounted at various places in a room, i.e., a diagnostic room 56, where a particular procedure is performed to verify that all steps of the procedure are taking place.

As illustrated in FIG. 3, specific elements of the inventive system 20 include: 1) portal readers 38; 2) bed or examination chair mounted proximity readers 40a; 3) task area proximity readers 42, 44, 46, 48, 50, 52, 54 and 56; 4) passive RFID tags 26 for caregivers 27a, patients 27b, and equipment 27c; 5) data presentation software; and 6) data compression, storage and analysis software. In this description, the proximity readers are generally referred to by number 22 and proximity readers associated with a specific station/room/equipment are specifically referred to with different numbers, but all proximity readers perform similar functions and are of similar design. The system 20 will be functional and valuable with a subset of these elements—for example, the portal readers 38 could be eliminated and only bed proximity readers 40a used if the desired information was specifically time spent with patients, but all would be present in the preferred instance.

A glove/robe station 46 is intended for obtaining a new glove and robe combination and/or to dispose of a used glove and robe combination. Glove/robe stations 46 are typically used for patients that are contagious. There is preferably a glove/robe station 46 located at the entrance to any room containing a highly contagious patient. The glove/robe station 46 may include disposable gloves, robes, and/or masks.

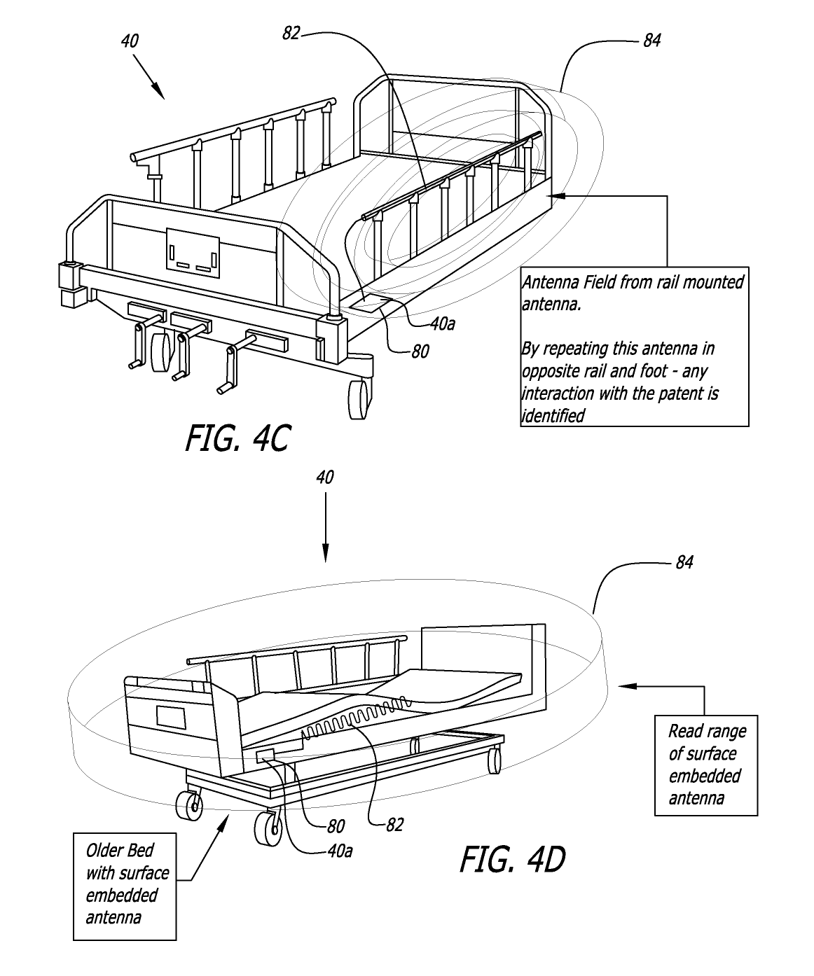

The bed or exam chair mounted proximity readers 40a are illustrated in FIGS. 4A and 4B. FIGS. 4A-D are illustrative drawings depicting various ways in which readers 22 can be mounted to patient furniture including hospital beds 40 and present detectable signals. When a patient 27b occupies a hospital bed 40 the associated bed tag reader 40a will detect that a patient 27b has entered and/or is residing in the bed 40. Typically the patient 27b will be wearing an RFID wristband 26 that is picked up by the reader 40a. When a caregiver 27a wearing a tag 26 is detected it will be indicative that the associated caregiver 27a is providing a service to the patient 27b in the particular bed 40 with which the reader 40a is associated. The computer server 30 will use tag readings from the tag 26 on the caregiver 27a and the tag 26 on the patient 27b to infer that there has been an interaction there between. The result is an input data record 68 with a timestamp 66 that documents each interaction; the latest such input data record documents the “last seen” status of the bearer of a particular tag 26.

Each hospital bed 40 has a “read range” which is a distance within which the RFID reader 40a will detect an RFID tag 26 from an asset 27. An asset 27 may be a caregiver, a patient, a medical device, or medical equipment carrying an RFID tag 26. The ideal read range would include the area above the bed 40 and a region extending around the bed 40—preferably not more than thirty inches from the bed 40 in a lateral (orthogonal to vertical) direction. The methods of incorporating antennas as depicted in FIGS. 4A and 4B are intended to provide this read range although other effective designs are possible.

In one embodiment, the hospital bed 40 may incorporate an RFID antenna 82 into the bedrails and/or the pads of the bed 40 that are coupled to the reader 40a. In another embodiment, both the head and foot of the bed incorporate an RFID reader 40a. FIG. 4B depicts older hospital beds or chairs that may be retrofitted with RFID readers 40a with antennas 82. The antennas 82 may be mounted under mattresses or embedded in pads.

FIG. 4C depicts the read range 84 of a bedrail mounted antenna 82. A combination of an antenna 82 in the rails and foot of the bed 18 may be sufficient to assure interaction with a wristband RFID tag 26 of a patient 27b as well as a tag 26 worn by a provider 27a. FIG. 4D depicts the read range 84 for a surface embedded antenna, e.g., a reader antenna 82, mounted under or within a mattress on the bed 40.

The desired effect is to have a read range 84 that surrounds the sides of the bed 40 (FIG. 4C) and the area above the bed 40 (FIG. 4D), but does not extend more than thirty inches beyond the perimeter of the bed 40. This is ideally accomplished through the use of antenna components 82 integrated in the bed 40 structure and rails but can alternately be achieved by retrofitting appropriate readers 40a under the head and foot of the bed 40. In addition, reader antennas 82 can be embedded in the surfaces that are placed on the bed 40. The antennas 82 and readers 40a are tuned to optimize the read range 84 for an area that extends thirty inches on each side of the bed 40.

By embedding the antenna components 82 in the rails of the bed 40 or exam chair, or alternately in the mattress surface, control over the read range 84 is maintained and proximity to the patient 27b is assured. The important factor here is that read range 84 is controlled and predictable. This is accomplished by tuning the antenna 82 both in terms of directional aspects as well as in power aspects.

RFID enabled hand wash stations proximity readers and for other work areas have been known in the industry, but storage and integration of bed-centered location, task and time data (which is inherently available knowing the location of the reader) for retrospective analysis has not been offered in the market.

Real time alerts and alarms can be set for a wide range of situations from exceeding the time that a patient should be left alone to equipment which has been left idle for longer than normal periods of time. Alerts for patients who leave their bed unexpectedly can also be triggered. All of these alarms and alerts are integrated to a physiological monitor for the patient such that the clinician has one place to look for all relevant patient centered information.

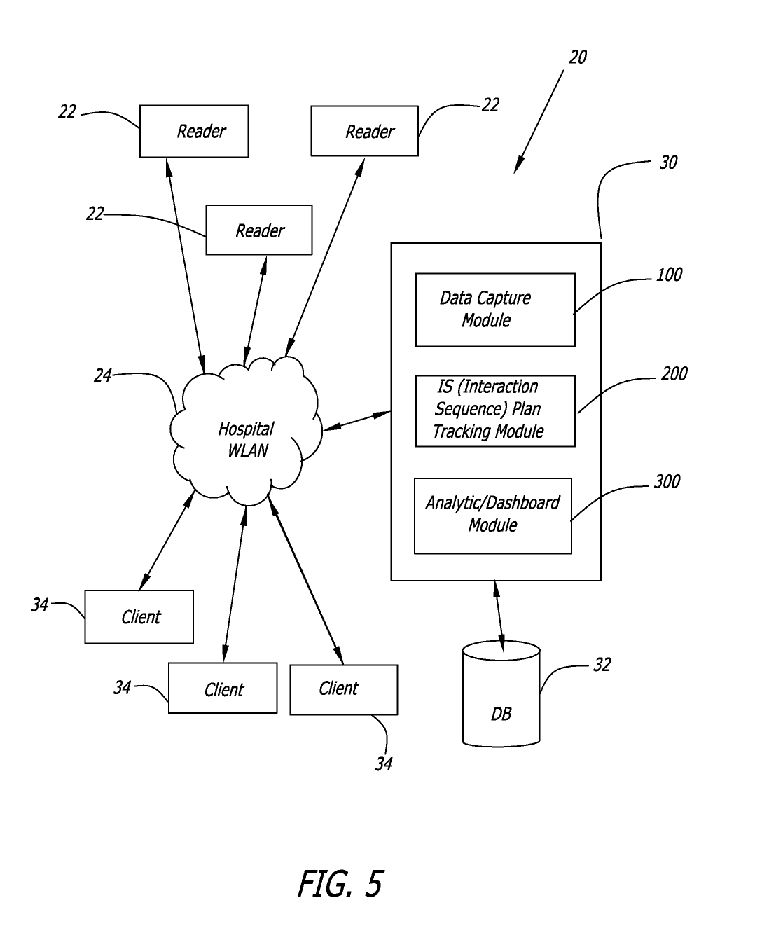

FIG. 5 depicts a block diagram of system 20 including readers 22, network 24, client devices 34, and a computer server 30. The computer server 30 may be implemented with a single or multiple computers. The computer server 30 includes three software modules—a data capture module 100, an IS (interaction sequence) plan tracking module 200, and an analytics/dashboard module 300 that are stored in memory so as to execute in computer system 12. Although FIG. 5 depicts these as three separate modules they may or may not be separate. They may be implemented as one large program or as separately executing modules. Modules 100, 200, and 300 may all be resident on a single computer server 30 or may be distributed individually to multiple computers. Data capture module 100, for example, may be distributed into multiple individual computers and may be directly linked to readers 22 rather than communicating through network 24.

Data capture module 100 is configured to receive data elements 60 from readers 22. Data capture module 100 stores input data records 68 on database 32 with each input data record 68 containing one data element 60. Data capture module 100 may also be configured to process the input data records 68 to define interaction records, inferred interaction records, or tag interactions as will be discussed later.

IS plan tracking module 200 is configured to track the progress of each IS plan 72. An IS plan 72 may define a deadline-driven service that a caregiver 27a is to provide to a patient 27b. An IS plan 72 may also define other types of plans such as those that are initiated by a patient admission or a doctor order for ongoing services to be provided to a patient. IS plan tracking module 200 also generates alerts that indicate when an actual sequence of interactions is insufficient and metrics that are used to “grade” the actual realization of interaction sequences.

Analytics and dashboard module 300 is configured to analyze the metrics and/or other data from IS plan tracking module 200 and to provide visual retrospective metrics as to the effectiveness of the patient care environment in providing care to patients and in utilizing facility assets. The dashboard module 300 may also provide a visual display of the “last seen” status of each mobile asset 27 (e.g., a patient, caregiver, or equipment) wearing a tag 26 based on an input data record 68 having the most recent timestamps 66 and the tag ID 64 associated with the asset 27.

The system 20 according to FIG. 5 has substantial advantages over traditional real time systems due to the much lower cost of the equipment implementation and the reduced amount of data that needs to be handled. This is because the system 20 tracks and analyzes interactions between assets 27 as opposed to a continuous location of the assets 27. However, it is possible that a RTLS system may be used in combination with system 20 such that location data may supplement the interaction data. In such a case, computer server 30 would also gather and analyze the RTLS data along with the interaction data in order to provide location data where it is needed the most or when a special study needs to be conducted. In one embodiment, the interaction data covers the entire patient care environment whereas the RTLS data is used in select locations (e.g., an operating room) within the facility.

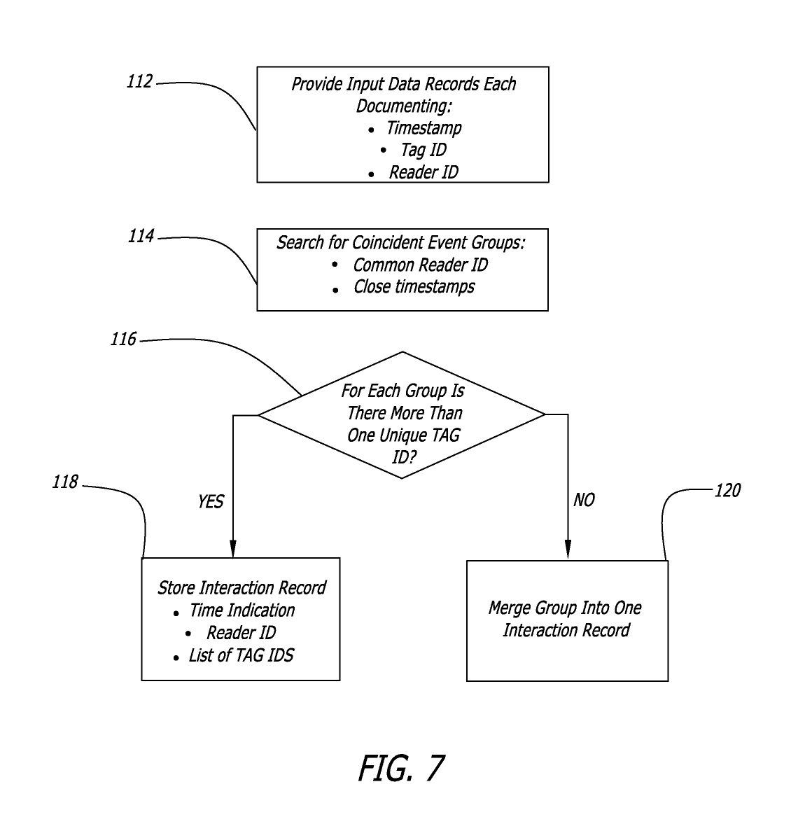

FIG. 6 depicts a flow of information through the system 20 as modules 100, 200, and 300 are executed by computer server 30. Although some particular functions of the modules 100, 200, and 300 are being illustrated, it is to be understood that the functions can be divided up between modules in different ways and that there are variations to how these functions are to be implemented. Generally speaking, module 100 gathers and processes data, and performs record keeping functions. The module 100 acquires data from the readers 22, processes the data to form data elements 60, input data records 68 and interaction records 70, and then stores those elements/records in the database 32 (see FIG. 7 also).

As illustrated in step 102, the module 100 receives data elements 60 from readers 22. According to step 104 an input data record 68 is created and stored in database 32. An input data record 68 documents a reader 22 reading a tag 26. Each input data record 68 includes a reader ID code 62, a tag ID code 64, and a timestamp 66. In some cases, the input data record 68 may also include a reader location. This may be important if a reader 22 is attached to a mobile device such as a hospital bed 40 or mobile equipment 44.

According to step 106, module 100 stores input data records 68 in database 32. In an exemplary optional embodiment, module 100 may process the input data records 68 to define higher level interaction records 70 according to step 108. These higher level interaction records 70 are stored in database 32 according to step 110.

One example of a higher-level interaction record 70 is an “inferred interaction” record. An inferred interaction is an interaction that is surmised to have taken place based upon more than one input data record 68. An example would be a caregiver 27a visit to a patient 27b. During the visit a reader 22 may detect a tag 26 attached to a caregiver's 27a wrist multiple times. This may cause the generation of several input data records 68. In addition, the module 100 would process the tag ID 64 and reader ID 62 and output a record that includes information indicative of a particular caregiver 27a visiting a particular patient 27b during a particular time period that contains timestamps 66 of the input data records 68 being stored during that time period. This higher-level record 70 would be stored according to step 110.

A higher-level interaction record 70 is generally one that documents an interaction between two or more assets 27 which may be tagged. A tagged asset may be a caregiver 27a, a patient 27b, or equipment 27c to give several examples. A caregiver 27a adjusting equipment 27c for a patient 27b may be considered to be an interaction between three assets.

An exemplary process for generating higher level interaction records 70 is depicted in FIG. 7. The steps of this process are summarized in FIG. 6 as element 108. According to step 112, input data records 68 are provided to database 32. Each input data record 68 contains a data element 60 that includes a timestamp 66, a tag ID 64, a reader ID 62, and optionally location indicating data. According to step 114 the input data records 68 are searched for data records having common reader ID 62 values and timestamps 66 differences that are less than a threshold time difference value. The latter implies that the data capture was at the “same time” even if the timestamps 66 may be separated by a few seconds. According to step 114 the resultant input data records 68 are placed into a “group” of input data records having the same reader ID and “timeframe”. According to step 116 the module 100 then determines whether or not multiple tag IDs 64 are present.

If more than one tag ID 64 is in the group, then an interaction record 70 is generated 118 that includes the timestamp 66 range, the reader ID 62, and the list of tag IDs 64 that are involved. The interaction record 70 stored according to step 118 can be referred to as an interaction between multiple assets 27 each having a tag 26.

If there is only one tag ID in the group then the input data records 68 are merged 120 into an interaction record 70 and stored. The merged interaction record 70 includes the input data records 68 located in the search according to step 114. If, for a given input data record 68, a reader ID 64 indicates a patient hospital bed 40 and a tag ID 64 indicates a caregiver 27a, then the input data record 68 would imply an interaction between that caregiver 27a and a patient 27b known to be occupying that hospital bed 40.

The subsequent discussion of modules will refer to interaction records. These may be individual input records or they may be higher level interaction records that include multiple input data records. An interaction record may include inferred data that was not present in the input data record. For example, the interaction records may include names or other identifications of the entities in addition to their associated tag ID values that are obtained by searching database 14.

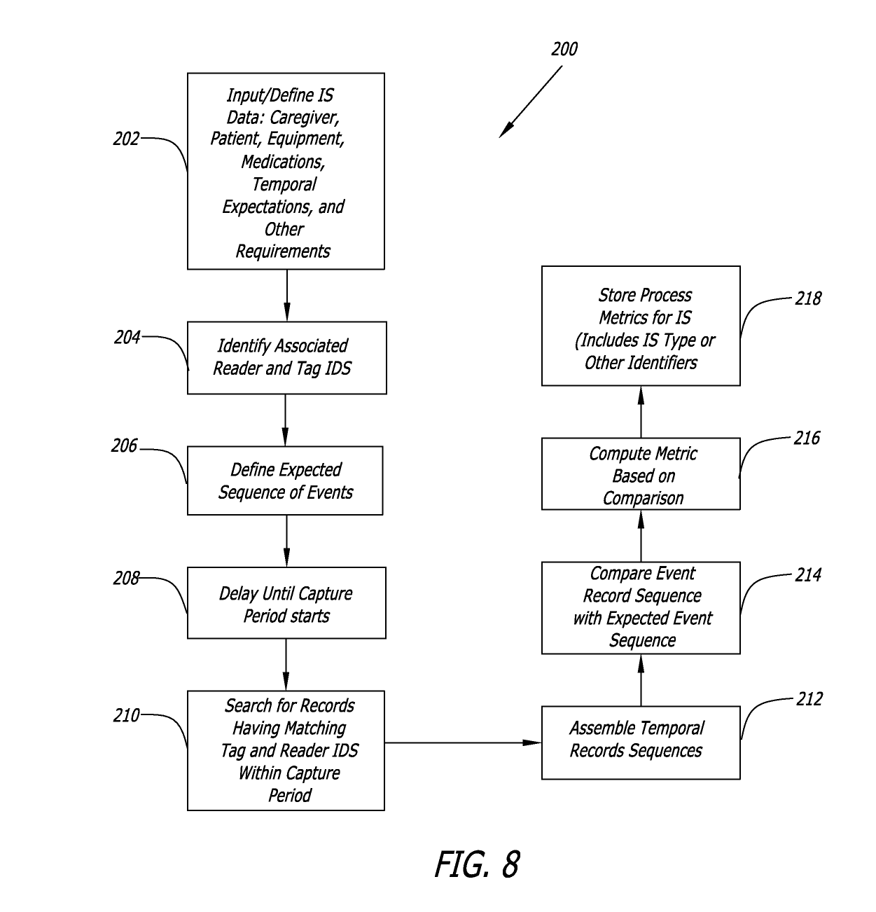

Referring back to FIG. 6 and to FIG. 8 process steps for module 200 are depicted in process flow and flow chart form respectively. According to step 202 a new IS plan 72 is started and the associated IS plan information is received by module 200. An IS plan 72 may define parameters for a service to be provided by a caregiver 27a to a patient 27b. Data received by module 200 includes a caregiver identity, a patient identity, equipment involved (if applicable), an IS plan defined time period, and various other requirements.

In an exemplary embodiment, a defined time period for an IS plan 72 includes a maximum time period and an expected time period. The expected time period includes a starting and ending time during which the IS plan 72 is expected to be carried out according to the policies of the patient care environment. Failure to carry out the IS plan 72 within that time period would indicate that the interaction sequence is either late or not occurring. The maximum time period includes the start and end of a time period that bounds all possible times during which the IS plan 72 could be carried out whether or not the IS plan 72 is performed on time. Therefore, the maximum time period contains not only the expected time period but includes additional time (before and/or after) in order to monitor processes or sequences within the IS plan 72 that are at least partially performed outside of the expected time period.

Step 202 may be automatically performed whenever a new patient 27b is admitted to a patient care environment 36. When a patient 27b is admitted and given an RFID tag 26 there will be associated assets such as a caregiver 27a, equipment 27c, expected medications, and other requirements that are initially associated with the patient 27b. Step 202 may also be performed based upon a doctor order or based upon an alert from a patient monitor, e.g., a cardiac monitor.

According to step 204 reader ID 62 values and tag ID 64 values are identified for the IS plan 72. This may be done by querying database 32 within which reader ID 62 values and tag ID 64 values are correlated with assets 27. An asset 27 may be one of a patient 27b, caregiver 27a, equipment 27c, location, (hospital) patient bed 40, medication dispense station, hand wash station 42, glove (and/or robe and/or mask) station 46, nursing station, or a room (with reader at the entrance) 38 to name some examples.

As part of step 204, various identifications are associated with each other. For example, a tag ID 64 of a patient 27b may be associated with a tag ID 64 of equipment 27c. A tag ID 64 of a caregiver 27a may be associated with a tag ID 64 of patient 27b and a tag ID 64 of equipment 27c. These associations may be stored in an EMR (electronic medical record) in database 32.

According to step 206, an expected interaction sequence between the identified assets 27 is defined for the IS plan 72. The expected interaction sequence includes certain interactions in a certain relative temporal order. The same interaction may happen twice. For example, a caregiver 27a may need to visit a wash station 42 before and after seeing a patient 27b. Also, there may be temporal limits on the interaction sequence. By way of example only, a temporal limit may include a visit to a hand wash station within a predetermined time before or after visiting a patient. One hour may not be acceptable if these are to be associated temporally adjacent interactions. In contrast, five minutes or less may be acceptable.

According to step 208 there may be a delay between receipt of the IS plan 72 and when a data capture period starts—which is the beginning of the maximum time period. According to step 210, database 32 is searched for interaction records 70 having timestamps 66 within the maximum time period that have tag ID 64 values and reader ID 62 values that are part of the IS plan 72. According to step 210 the identified interaction records 70 are accumulated and tagged as being part of the IS plan 72. Step 210 is an ongoing process that continues concurrently with later steps as the search is repeated and more interaction records 70 are identified and tagged as part of the IS plan 72.

According to step 212 the interaction records 70 found in step 210 are analyzed to see how well they match the expected sequence of interactions for the IS plan 72. In an exemplary embodiment, the interaction records 70 are assembled into a temporal interaction record sequence—the interactions are organized into a sequence having monotonically increasing timestamps.

According to step 214 the assembled interaction sequence is compared with the expected sequence of interactions from the IS plan 72. According to step 216 one or more metrics are computed based upon the comparison in step 214. According to step 218 the metrics are stored in database 32 as metric records. One example of a metric is timeliness of the IS plan 72 and whether all of the interactions occurred in the correct sequence. An example of a timeliness metric may be whether the timestamps of the interaction records all fell within the expected time period. Another metric may check whether all of the interactions in the expected interaction sequence were included among the interaction records 70. Another metric may check whether the interaction record sequence assembled in step 212 is exactly the same as the expected interaction sequence. If the ordering of the interaction sequence is the same then a final metric may be whether the differences in timestamps for adjacent interaction records are within expected time difference limits.

Part of the analysis according to steps 210 to 218 can be a determination as to whether a specified protocol, as defined by the expected sequence of interactions, has been properly administered to a patient. The protocol can be based on care to the patient or it can be based on other factors such as avoiding the spread of infection.

### Embodiment 1

### Schedule II Pain Medication Delivery (FIG. 8)

An example of an IS plan 72 according to step 202 is a request for a caregiver 27a to inject a schedule II pain medication into the IV (intravenous) line of a patient 27b. The IS plan 72 is to be carried out within a twenty minute window, the expected time period, to be on time. Based on this IS plan 72 module 200 would define twenty minutes from the start of the IS plan 72 as bounding the expected time period and, for example, one hour to bound the maximum time period.

According to step 204, software module 200 would identify or receive a reader ID 62 corresponding to the hospital bed 40 of the patient 27b, a tag ID 64 corresponding to the administering caregiver 27a, and optionally a tag ID 64 corresponding to a witnessing caregiver 27a.

According to step 206 software module 200 would define the following expected sequence of interactions: (1) Pyxis® station or pharmacy 78 to have medication available, (2) administering and witnessing caregivers to receive medication, (3) administering caregiver to load up syringe with proper dose and discard remainder while witnessing caregiver documents process, and (4) administering caregiver and witnessing caregiver to proceed to patient bedside and deliver doses.

According to step 210 module 200 would immediately begin searching for interaction records 70 (e.g., input data records 68) having certain combinations including: a reader ID 62 at Pyxis® station or pharmacy 78 and a tag ID 64 of administrating caregiver 27a; a reader ID 62 at Pyxis® station or pharmacy 78 and tag ID 64 of witnessing caregiver 27a; a reader ID 62 at nurses' station and tag ID 64 of administrating caregiver 27a; a reader ID 62 at nurses' station and tag ID 64 of witnessing caregiver 27a; a reader ID 62 at patient bed 40 and tag ID 64 of administrating caregiver 27a; a reader ID 62 at patient bed 40 and tag ID 64 of witnessing caregiver 27a; and a reader ID 62 at patient bed 40 and tag ID 64 of patient 27b.

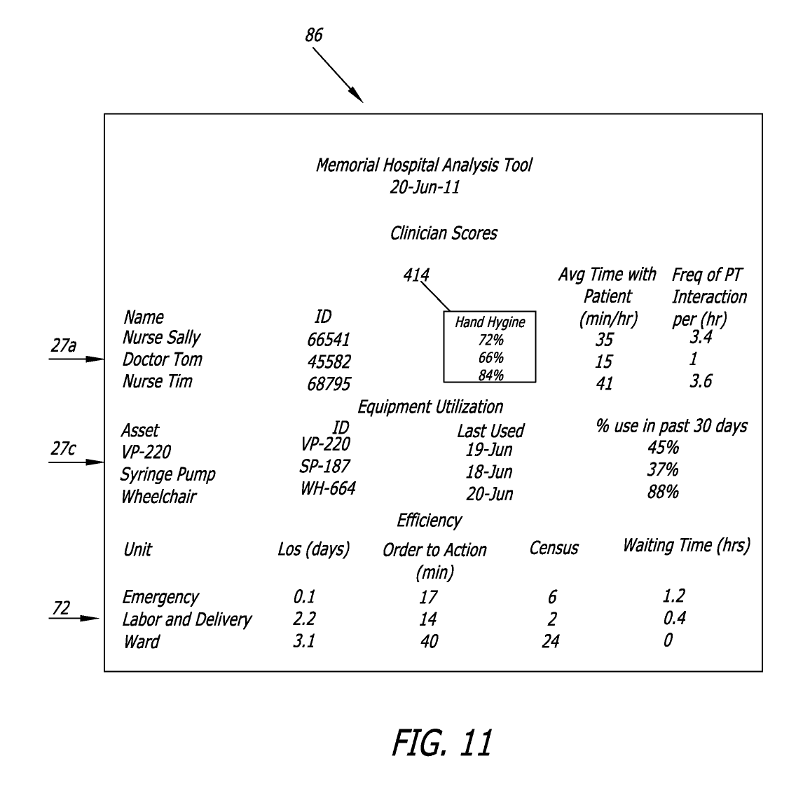

According to step 212 module 200 would assemble the interaction records according to timestamps generated at each reading. According to step 214 the assembled records would be compared to the defined sequence of interactions along with the expected time period. Metrics would be computed such as whether the temporal sequence of the interaction records match the expected sequence of interactions. If not then medication diversion might be suspected. Another metric may be the total elapsed time between receipt of the IS plan 72 and the last timestamp compared to the twenty minute expected time period. FIG. 12 is an example of a dashboard 86 that may graphically include such a metric.

### Embodiment 2

### Procedure Requiring Equipment Delivery (FIG. 8)

According to step 202, an IS plan 72 is received for a caregiver 27a to perform a procedure on a patient 27b requiring the delivery of equipment 27c. The patient 27b is also contagious. The procedure is not extremely urgent and will be performed within the expected time period or twenty-four hours as the equipment 27c may be available. According to this example, the expected time period is twenty-four hours and a maximum time period selected to be three days. The maximum time period corresponds to the maximum time that the interaction sequence would be expected to take based upon historical records.

According to step 204 the IS plan 72 would define an expected sequence of interactions that identify a reader ID 62 corresponding to a glove and robe station 46, a reader ID 62 corresponding to a patient bed 40, a tag ID 64 corresponding to a patient 27b, a tag ID 64 corresponding to a caregiver 27a, and a tag ID 64 corresponding to the equipment 27c. According to step 204, the tag ID 64 of the equipment 27c is associated with the tag ID 64 of the patient 27b for a specified time period of usage for the equipment 27c.

According to step 206 the IS plan 72 would define the following expected sequence of interactions: equipment 27c delivered to patient bed 40; caregiver 27a using glove and robe station 46 to put on gloves and robe; caregiver 27a performing procedure at bed 40 of patient 27b; caregiver 27a using glove and robe station 46 to remove gloves and robe. According to step 208 the system delays capturing data for a period of time wherein both the equipment and the caregiver are not available.

After the time delay the module 200 begins to search for interaction records 70 that match the IS plan 72 according to step 210. These records 70 include: reader ID 62 of the bed 40 and tag ID 64 of the equipment 27c; reader ID 62 of the glove/robe station 46 and tag ID 64 of the caregiver 27a to put on gloves and robe; reader ID 62 of the bed 40 and tag ID 64 of the caregiver 27a; and reader ID 62 of the glove/robe station 46 and tag ID of the caregiver 27a to remove gloves and robe.

According to steps 212 and 214 module 200 compares a temporal sequence of the interaction records 70 with the expected sequence of interactions. The temporal sequence of interaction records is based upon the timestamps 66. A timeliness metric may include the time elapsed before the sequence is complete relative to the twenty-four hour expected process time. Another metric could include verification that the glove/robe station is visited before and after the procedure.

### Embodiment 3

### A Change in Indication or Diagnosis for a Patient: Patient is Contagious and Less Stable

In this third example an existing IS plan 72 is replaced with a new IS plan 72 based upon a change in the diagnosis and/or condition of the patient 27b. In this example the patient 27b that was stable and not contagious is now unstable and contagious. According to step 202 a new IS plan 72 replaces and supersedes an existing IS plan 72 having an addition of new equipment 27c, i.e., cardiac monitoring, new medications (heart rhythm medication), new temporal expectations (defined time periods between visits is reduced), and other requirements (glove and robe). This example is different than the prior two because there are actually two different interaction sequences—one for each of two caregivers 27a. The expected sequence time for the sequences is ten minutes or minimum and the maximum sequence time is thirty minutes because this is a borderline emergency.

According to step 204 assets associated with the new IS plan 72 are identified. These may include a tag ID 64 for heart monitoring equipment 27c, a tag ID 64 for a first caregiver 27a interfacing monitoring equipment with patient, a tag ID 64 for a second caregiver 27a providing medication, a reader ID 62 associated with the patient's bed 40, and a reader ID 62 for a glove and robe station 46.

According to step 206 a first sequence of interactions such as the following are defined: heart monitoring equipment delivered to patient's room; the first caregiver visiting robe and glove station; the first caregiver interacting with heart monitoring equipment and patient to interface the patient and the equipment; and the first caregiver visiting robe and glove station for disposal of the robe and gloves used. According to step 206 there is also a second sequence of interactions including: the second caregiver visiting robe and glove station; the second caregiver visiting Pyxis® station or pharmacy to receive medication; the second caregiver interacting with patient to administer medication; the second caregiver visiting robe and glove station a second time for disposal. The sequences above are to be performed immediately but there are others that will be performed on an ongoing basis including frequent visits of other caregivers to the patient that are more frequent than those planned for the prior IS plan.

According to step 208 there is no delay period prior to data collection because the initiation and tracking of the new IS plan 72 is urgent. According to step 210 a search is started for interaction records 70 having timestamps 66 within the maximum time period that identify the assets 27 involved with the new IS plan 72. A first sequence is expected to be the following: a tag ID 64 corresponding to heart monitoring equipment 27c and a reader ID 62 corresponding to the bed 40; a tag ID 64 corresponding to the first caregiver 27a and a reader ID 62 corresponding to the glove/robe station 46 nearest the patient location; a tag ID 64 corresponding to the first caregiver 27a and a reader ID 62 corresponding to the bed 40; and a tag ID 64 corresponding to the first caregiver 27a and a reader ID 62 corresponding to the glove/robe station 46. A second sequence is expected to be the following: a tag ID 64 corresponding to the second caregiver 27a and a reader ID 62 corresponding to the Pyxis® station or pharmacy; a tag ID 64 corresponding to the second caregiver 27a and a reader ID 62 corresponding to the glove/robe station 46; a tag ID 64 corresponding to the second caregiver 27a and a reader ID 62 corresponding to the bed 40; and a tag ID 64 corresponding to the second caregiver 27a and a reader ID 62 corresponding to the glove/robe station 46. There would likely be a temporal overlap of the first and second sequences.

According to step 212 temporal sequences of the above interactions are constructed based upon the timestamps 66. According to step 214 the temporal sequences are compared to the expected interaction sequences. At this point, a substantial deviation of the constructed interaction sequences from the expected sequences would trigger an alarm due to patient health and infection risks. Steps 216 and 218 are performed for computing and storing process metrics.

### Embodiment 4

### IS Plan Triggered by Heart Monitoring Equipment

In a fourth embodiment step 202 results in an IS plan 72 being triggered by an alert from heart monitoring equipment 27c. This alert is indicative of a cardiac emergency. In additional to audible and/or visible alarms there would be an IS plan 72 that would include a number of caregivers 27a and sequence of interactions for each. The IS plan 72 may also identify cardiac related equipment 27c for delivery to the patient 27b. The expected sequence time for the first steps would be likely be less than a minute and a maximum sequence time would likely be 5 or 10 minutes. Steps 204-218 would proceed in a manner similar to that described for earlier examples.

Referring back to FIG. 6, module 300 provides a retrospective analysis of the metrics that are obtained from module 200. While module 200 focuses on monitoring interactions against interaction sequence targets, module 300 provides a retrospective analysis in the form of summarizing dashboards 86 and in response to queries coming from a client device 34. According to step 302 metrics produced from various IS plans 72 are processed. According to step 304 the results of this processing are displayed in the form of text data, graphics, or as a dashboard 86. The action of step 302 can be ongoing or it can be in response to a query arriving from a client device 34. Additionally, step 304 can either be automatically generated or in response to a query.

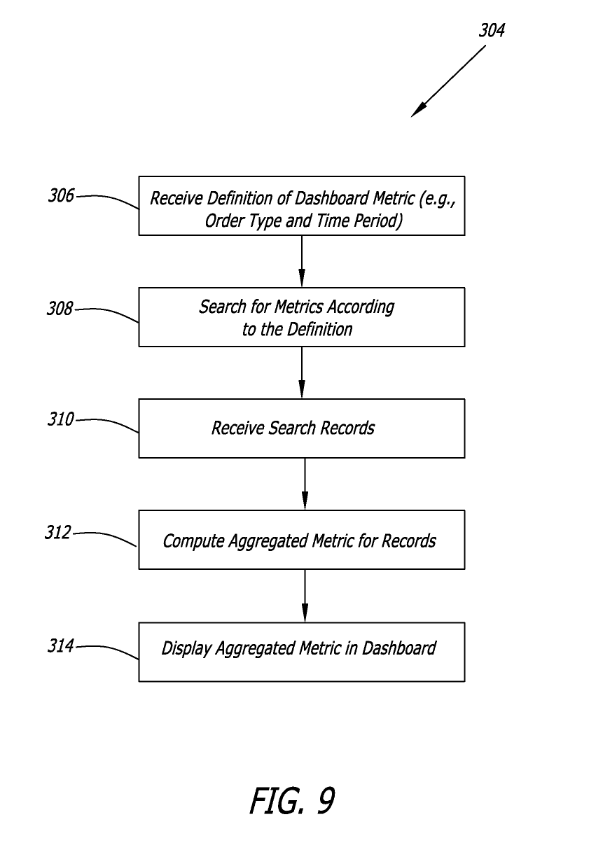

One embodiment of a dashboard generation process 304 of FIG. 6 is also represented as a flow chart form in FIG. 9. According to step 306 a definition of a dashboard metric is provided. According to step 308 a search for metric records according to the definition is carried out. According to step 310 the appropriate metric records are found. According to step 312 the metrics records are aggregated. According to step 314 the aggregated metric is displayed in a dashboard. There may be variations. For example, a dashboard may not display an aggregated metric but individual metrics or statuses of individual entities. Such an individualized tracking process may be performed by either module 200 or 300.

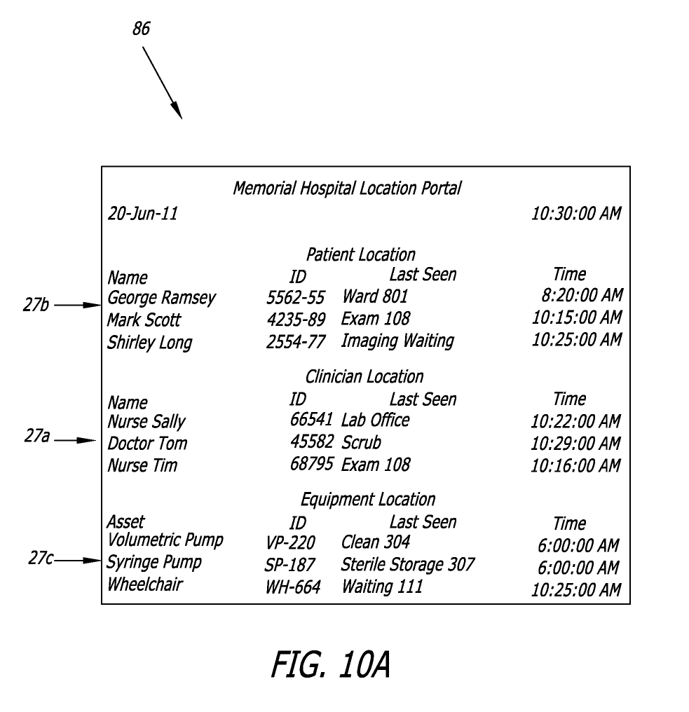

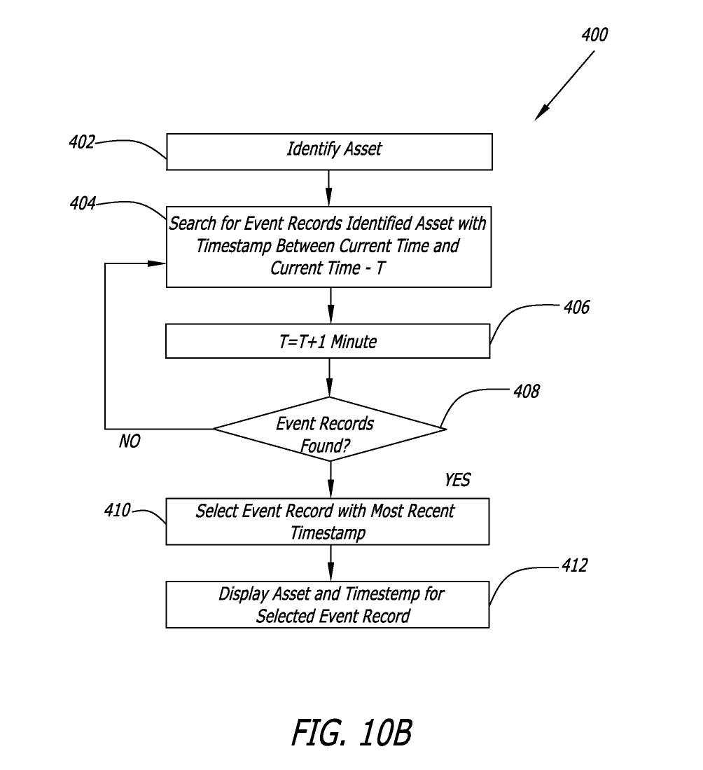

FIGS. 10A, 10B and 11 illustrate charts of information collected from the dashboard module 300. FIG. 10A depicts a status dashboard 86 and FIG. 10B depicts a method that provides “last seen” data for various assets including patients 27b, caregivers 27a (i.e., clinicians), and medical equipment 27c. FIG. 10A is an exemplary listing of “last seen” dashboard 86 containing data collected by the system 20. FIG. 10B depicts a process 400 by which the system 20 utilizes input data records 68 to generate the “last seen” data included in the dashboard 86 seen in FIG. 10A.

The “last seen” data search process 400 begins with one or more asset(s) 27 to be tracked being identified 402, as by a list of assets 27 being inputted, provided, or defined. This may be defined by a setup module which a user of client device 34 indicates which entities to track. Steps 402-412 are to be performed for each identified asset 27. Part of step 402 is to determine a tag ID 64 value that corresponds to the asset 27 being tracked.

According to step 404, system 20 searches for input data records 68 or interaction records 70 that have the tag ID 64 value corresponding to the asset 27 and having a timestamp 66 corresponding to the immediate past, i.e. current time minus T, where T is a predetermined time interval such as one minute. According to step 406, T is incremented by a selected time increment, such a one minute. According to step 408 the system 20 determines whether any records have been found. If not, then step 404 is repeated for the current time minus the now higher value of T. This process is repeated until at least one input data record 68 or interaction record 70 is found according to step 408. Then, according to step 410 the input data record 68 or interaction record 70 with the most recent timestamp 66 is selected. According to step 412 the asset 27 and timestamp 66 are displayed for the selected input data record 68 or interaction record 70. Thus the “last seen” data for the asset 27 is displayed.

FIG. 11 depicts a dashboard 86 that includes aggregated metrics generated by module 300 for various assets including caregivers 27a, equipment 27c, and types of IS plans 72. These aggregated metrics are computed by searching for interaction records or individual metric records for each of the assets depending on the type of metric to be computed. Retrospective scoring of hand hygiene compliance, measures of nurse-patient interaction times, and frequency of nurse-patient interactions are all enabled. In addition, visitors could be required to wear RFID tags in order to provide some control over access to sensitive patients (babies, victims of crimes, etc). Cleaning and maintenance staff can also be tracked to measure efficiency in turning rooms for patients.

For example consider the metric “hand hygiene” 414. This metric indicates the percentage of time that a caregiver 27a properly used a hand wash station in IS plans 72 that required the use of a hand wash station 42. Referring back to step 216 of FIG. 8, a hand wash metric may provide a value of 1 if a hand wash interaction record 70 was correctly included in a sequence of interaction records when the expected sequence of interactions includes a hand wash step. Otherwise the value would be zero. The metric 414 is later computed in the following manner. All hand wash metric records are found for a given caregiver. The sum of the metric values divided by the number of interaction records would provide the metric 414.

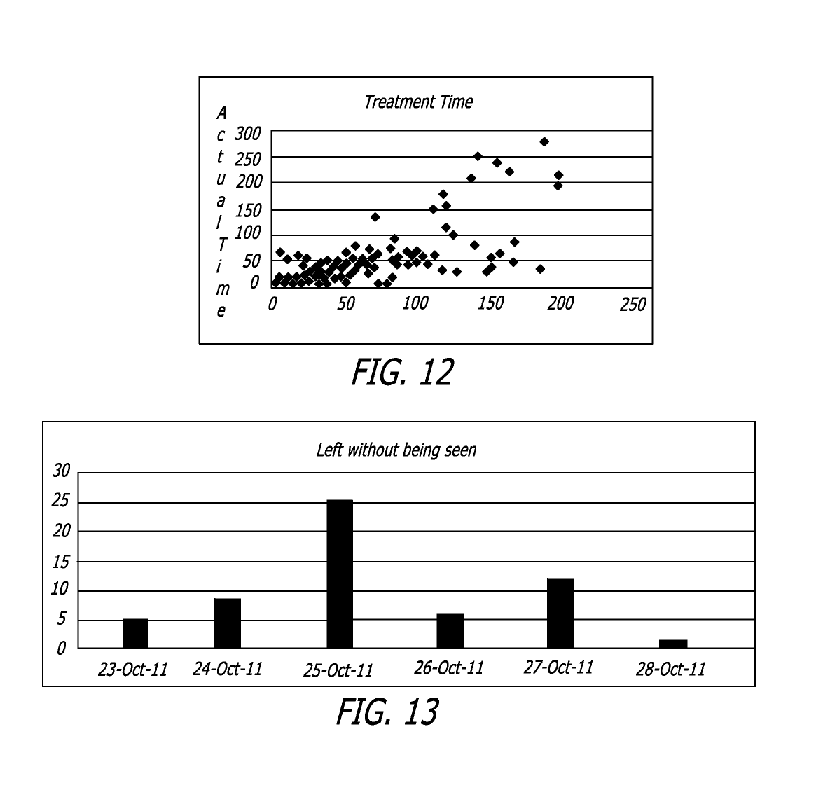

The stored information can be cross referenced to imported data from Health Information System (HIS) (order entry), nurse call and billing systems to allow higher level analysis to occur as illustrated in FIGS. 12 and 13. FIG. 12 depicts a graphical chart for a metric such as coordinates depicting the actual process time versus the expected process time for a number of IS plans. FIG. 13 depicts a graphical chart for a metric indicating how many patients arrived at the patient care environment and left the facility without ever being seen by a caregiver. This can be computed by searching for interaction records documenting interactions between a patient tag ID and a caregiver tag ID for patients who have been discharged. If no such records can be found for a given patient discharged on a particular date then a value of 1 is added to the metric for that discharge date. The sums of the values are graphically shown according to FIG. 13.

Metrics for “time to test” measuring how long it takes for a certain order to be fulfilled or “time to treatment” measuring the interval from a diagnosis to treatment are all enabled. As healthcare costs continue to be of concern, process improvement methods such as Lean or Kaizen (which are data driven methods) are enabled with this stored information. Ultimately, hospitals will be able to garner a much tighter understanding of costs related to disease states and procedures so that budgeting and bidding of contracts can be better informed.

Data Stored for Process Improvement

From the stored location data, the following are examples of higher level analysis that can be performed:
Percent of time each caregiver visits hand wash station prior to arriving at patient bedside;
Percent of time each caregiver visits hand wash station upon leaving patient bedside;
Percent of time caregivers spend at patient side;
Percent of time that assets are located at a particular patient's bedside—useful for utilization and billing analysis;
Average and maximum time between caregiver-patient interactions;
Average, median, min, max length of caregiver-patient interactions;
With data imported from HIS system, average, median, min and max times from entry of an order until the clinician arrives at the bedside;
With data imported from Nurse Call System, average, median, min and max times from patient call until the clinician arrives at the bedside;
Analysis of time caregivers spend at bedside versus in procedure areas.

While the above description is focused on a hospital setting, it is equally applicable to nursing homes. The frequency of interaction and response time to calls are often contentious issues for long term care facilities. All of the elements are applicable in this market.

Another embodiment of the present invention is for use in the home. Increasing numbers of patients are being cared for at home requiring a number of regular visits from caregivers (respiratory therapists, physical therapists, nurses, dietary aids, etc). Tracking the frequency and length of these visits can be achieved using the same technical elements and using WAN to communicate to a central storage location. Care Planning, Billing and service audits can all be performed using the caregiver-patient interaction and location data.

Although several embodiments have been described in detail for purposes of illustration, various modifications may be made without departing from the scope and spirit of the invention.

What is claimed is:

1. A process for performing asset tracking in a patient care environment, comprising the steps of:
receiving a plurality of data elements from a tracking system in the patient care environment, each data element having a reader identification code corresponding to one of a plurality of readers, a tag identification code corresponding to an identification tag attached to one of a plurality of assets and read by one of the readers, and a timestamp corresponding to a time that the identification tag was read by the reader;
storing interaction records in an electronic database wherein each interaction record corresponds to one or more of the plurality of data elements received from the tracking system;
generating a plurality of interaction sequence plans, each interaction sequence plan including a defined time period and an expected sequence of interactions between assets in the patient care environment during the defined time period; and
performing an analysis for each interaction sequence plan, the analysis comprising the steps of:
searching the database;
identifying interaction records in the database having timestamps within the defined time period and identification data corresponding to one or more of the assets;
comparing the identified interaction records with the expected sequence of interactions; and
generating a metric based upon the comparison of the identified interaction records with the expected sequence of interactions.

2. The method of claim 1, wherein the defined time period includes a maximum time period and an expected time period, the expected time period falling within and being shorter in duration than the maximum time period, and wherein the searching and identifying steps are performed over the maximum time period such that interaction records are identified that are outside of the expected time period.

3. The method of claim 1, wherein the analysis further comprises the step of assembling a temporal sequence of the identified interaction records before comparing them with the expected sequence of interactions.

4. The method of claim 3, wherein the metric is based upon how closely the temporal sequence of the identified interaction records matches the expected sequence of interactions.

5. The method of claim 1, further comprising the step of performing a retrospective analysis on metrics generated for a plurality of interaction sequence plans.

6. The method of claim 1, further comprising the step of continuously storing input data records in the electronic database, each input data record containing one of the data elements.

7. The method of claim 6, wherein each interaction record corresponds to one or more input data records and at least some interaction records correspond to more than one input data record.

8. The method of claim 6, wherein each interaction record is one of the input data records.

9. The method of claim 1, wherein the plurality of interaction sequence plans are generated based upon an alert from patient monitoring equipment.

10. The method of claim 1, wherein the tracking system is a real-time tracking system.

11. A system for performing asset tracking in a patient care environment, comprising:
a computer processor and electronic database connected to a network, wherein the computer processor includes a data capture module configured to track assets in the patient care environment and a data analysis module configured to analyze a plurality of interaction sequence plans;
the data capture module programmed to receive a plurality of data elements from a tracking system in the patient care environment, each data element having a reader identification code corresponding to one of a plurality of readers, a tag identification code corresponding to an identification tag attached to one of a plurality of assets and read by one of the readers, and a timestamp corresponding to a time that the identification tag was read by the reader; and to store interaction records in the electronic database wherein each interaction record corresponds to one or more of the plurality of data elements received from the tracking system; and
the data analysis module programmed to generate a plurality of interaction sequence plans, each interaction sequence plan including a defined time period and an expected sequence of interactions between assets in the patient care environment during the defined time period; to search the database and to identify interaction records in the database having timestamps within the defined time period and identification data corresponding to one or more of the assets; to compare the identified interaction records with the expected sequence of interactions; and to generate a metric based upon the comparison of the identified interaction records with the expected sequence of interactions.

12. The system of claim 11, wherein the defined time period includes a maximum time period and an expected time period, the expected time period falling within and being shorter in duration than the maximum time period, and wherein the data analysis module is programmed to search the database and identify interaction records having timestamps within the maximum time period such that interaction records are identified that are outside of the expected time period.

13. The system of claim 11, wherein the data analysis module is further programmed to assemble a temporal sequence of the identified interaction records before comparing them with the expected sequence of interactions.

14. The system of claim 13, wherein the metric is based upon how closely the temporal sequence of the identified interaction records matches the expected sequence of interactions.

15. The system of claim 11, wherein the data analysis module is further programmed to perform a retrospective analysis on metrics generated for a plurality of interaction sequence plans.

16. The system of claim 11, wherein the data capture module is further programmed to continuously store input data records in the electronic database, each input data record containing one of the data elements.

17. The system of claim 16, wherein each interaction record corresponds to one or more input data records and at least some interaction records correspond to more than one input data record.

18. The system of claim 16, wherein each interaction record is one of the input data records.

19. The system of claim 11, wherein the tracking system comprises a plurality of readers distributed throughout the patient care environment, the plurality of readers linked to the network, and a plurality of identification tags attached to the assets in the patient care environment.

20. The system of claim 11, wherein the computer processor is configured to receive an alert from patient monitoring equipment.

21. The system of claim 20, wherein the plurality of interaction sequence plans are generated based upon the alert from the patient monitoring equipment.

22. The system of claim 11, wherein the tracking system is a real-time tracking system.

23. A non-transitory computer readable medium having stored thereon computer executable instructions for performing asset tracking in a patient care environment, the instructions comprising the steps of:
receiving a plurality of data elements from a tracking system in the patient care environment, each data element having a reader identification code corresponding to one of a plurality of readers, a tag identification code corresponding to an identification tag attached to one of a plurality of assets and read by one of the readers, and a timestamp corresponding to a time that the identification tag was read by the reader;
storing interaction records in an electronic database wherein each interaction record corresponds to one or more of the plurality of data elements received from the tracking system;
generating a plurality of interaction sequence plans, each interaction sequence plan including a defined time period and an expected sequence of interactions between assets in the patient care environment during the defined time period; and
performing an analysis for each interaction sequence plan, the analysis comprising the steps of:
searching the database;
identifying interaction records in the database having timestamps within the defined time period and identification data corresponding to one or more of the assets;
comparing the identified interaction records with the expected sequence of interactions; and
generating a metric based upon the comparison of the identified interaction records with the expected sequence of interactions.
